(19) United States
(12) Patent Application Publication
(10) Pub. No.: US 2005/0281066 A1
(43) Pub. Date: Dec. 22, 2005

(54) Power converter

(76) Inventors: Patrick Wheeler, Long Eaton (GB); Jonathan C. Clare, Keyworth (GB); Lee Empringham, Beeston (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/511,234

(22) PCT Filed: Apr. 15, 2003
(86) PCT No.: PCT/GB03/01633

§ 371 Date: Aug. 17, 2005

(30) Foreign Application Priority Data
Apr. 15, 2002 (GB) 0208600.7

(51) Int. Cl. H02M 7/537

(52) U.S. Cl. 363/131

(57) ABSTRACT

In motor control of electric vehicles, a snubblerless 10 KVA Matrix Converter uses discrete 65 Amp, 1200 Volt MOS Controlled Tyhristors (MCTs) to minimise commutation time and so achieve the optimum waveform quality, particularly useful when controlling induction motors in applications where the controller may demand very low output voltages. The matrix converter has significant advantages over the conventional dc link converter by eliminating the dc link capacitor.

The present invention relates to power converters and to methods of power conversion.

There are numerous conventional arrangements for power conversion using matrices of bi-directional switches, for example as disclosed in U.S. Pat. Nos. 5,594,636 and 5,892,677 which involve four-step current commutation.

These arrangements employ a current commutation technique in which the command signals for each current direction in the bi-directional switch are staggered in such a way as to ensure the safe commutation of the current path between one bi-directional switch and the next.

According to the present invention, there is provided a converter having a plurality of bi-directional switch means arranged in a configuration, the converter comprising current commutation means to effect operation of the switch means to begin initiation of one switch means before de-activation of another switch means.

According to the present invention, there is provided a converter having a plurality of bi-directional switch means arranged in a configuration, the converter comprising current commutation means with means to effect an overlap between turning off a switch means and turn-on of a further switch means.

In this way, the commutation time for a converter is reduced compared to present conventional equipment. Such commutation times can be reduced to such levels as to approach or reach zero, and can even be slightly negative up to the total of the turn-off and turn-off delay times of the switching devices used. Thus, for example, the turn-off signal is sent to the out-going switch before sending the turn-on signal to the incoming switch, thereby to compensate for the long turn-off times of semi-conductor switching devices.

The initiation of one switch means may begin at any stage of the de-activation of the another switch means, for example at the start of such de-activation, or at some time during such de-activation, or at the end of such to de-activation.

Preferably, the converter comprises one or more of the following features:—
a first switch means and a second switch means whereby, in a first mode in use, the first switch means is activated, and the current commutation means is operable to activate the second switch means before the first switch means is de-activated.
the converter comprises means to minimise the commutation interval.
the converter comprises means to provide a commutation interval of less than those typically used as the Deadtime in a Voltage Source Inverter.
the converter comprises means to provide a commutation interval which approaches or equals zero.
the converter comprises means to provide a commutation interval which is slightly negative.
the converter comprises means to provide a commutation interval which is negative up to the total turn-off times for the switching devices used in the circuit implementation.
the converter comprises a plurality of switches and timers thereby to effect reduction of the commutation interval.

According to another aspect of the present invention, there is provided a method of operating a converter having a plurality of bi-directional switch means arranged in a configuration, the method comprising effecting current commutation to operate the switching means to begin activation of one switch means before de-activation of another switch means.

Preferably the method comprises one or more the following features:—
operating the current commutation means in order to activate a second switch means before a first switch means is de-activated.
minimising the commutation interval.
providing commutation interval of less than those typically used as the Deadtime in a Voltage Source Inverter.
providing a commutation interval which approaches or equals zero.
providing a commutation interval which is slightly negative.
providing a commutation interval which is negative up to the total turn-off times for the switching devices used in the circuit implementation
operating a plurality of switches and timers thereby to effect reduction of the commutation interval.

According to another aspect of the present invention, there is provided a computer software product directly loadable into the internal memory of a digital computer, comprising software code portions for performing the steps of the method of the present invention when said product is run on a computer.

According to another aspect of the present invention, there is provided a computer program directly loadable into the internal memory of a digital computer, comprising software code portions for performing the method of the present invention when said program is run on a computer.

According to another aspect of the present invention, there is provided a carrier, which may comprise electronic signals, for a computer program of the present invention.

According to another aspect of the present invention, there is provided electronic distribution of a computer program product or a computer program or a carrier of the present invention.

The present invention is applicable to a wide range of configurations of bi-directional switches, but particularly common are matrix converters implementing the 2-step current commutation operation, the 3-step current commutation operation or the 4-step current commutation operation, based on the output current direction for each output phase of the converter. With the critical central commutation interval reduced to zero these two methods become 1-step and 3-step commutation techniques.

Specific applications for the converter, or the conversion method, of the present invention are electric vehicles and other electric motor control situations.

Advantages of the present invention include the reduction or elimination of commutation time, the possibility of eliminating the dc link capacitor, lower conduction losses, and higher conversion efficiency. Furthermore, another advantage may be to make the commutation time slightly negative to compensate for the long turn-off times associated with power semi-conductor switching devices.

The present invention can be implemented by hardware, software, firmware or any suitable combination of such technologies, or even appropriate alternative technologies.

Also it is possible to use digital logic applications e.g. transistors, discrete logic devices, programmable logic devices, direct outputs from first microprocessors, as alternatives to a FPGA.

The present invention is also applicable to the control of machines which operate without shaft sensors and need high-quality waveforms to operate properly at low speeds and at standstill, e.g. sensorless drives.

The present invention is also applicable to space critical drives (e.g vehicles and aerospace actuators) and integrated drives in which the converter and motor are in a single package.

In a modification, the output current direction for each output phase of the converter may be determined from the voltages seen across the bi-directional switches.

The present invention can effect phase-conversion with any number of input and output phase being possible, as long as each is greater than or equal to one; e.g. from three-phase to single-phase, or it can maintain the phase-relationship (e.g. three-phase to three-phase).

In order that the invention may more readily be understood, a description is now given, by way of example only, reference being made to the accompanying drawings, in which:—

FIG. 1 is a schematic diagram of a converter of the present invention;

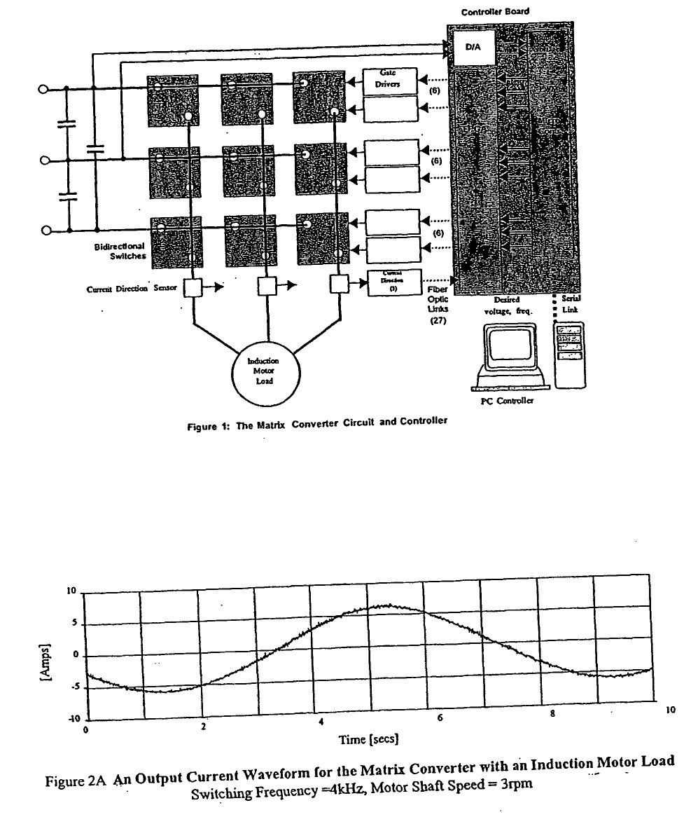

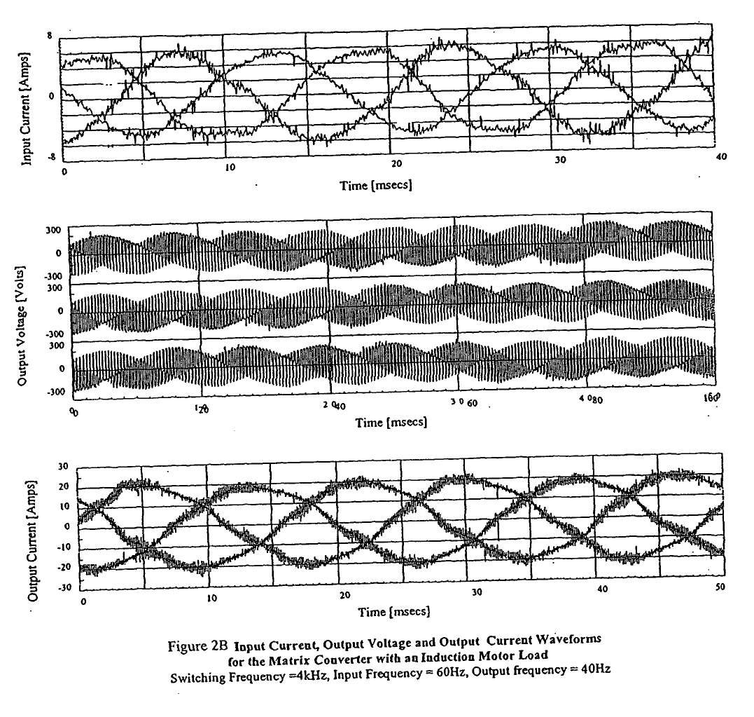

FIGS. 2A and 2B are a waveforms resulting from the converter of FIG. 1;

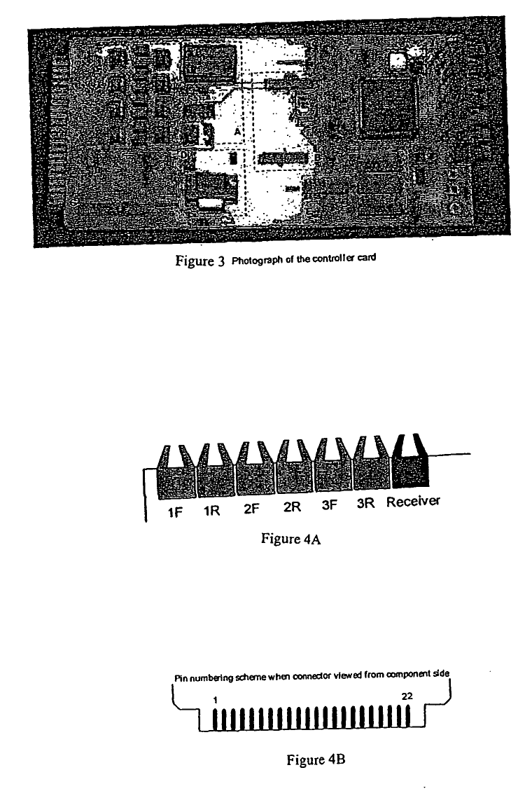

FIG. 3 shows the board layout of the converter of FIG. 1;

FIGS. 4A and B show fibre optic components and edge connectors, respectively, of the converter of FIG. 1;

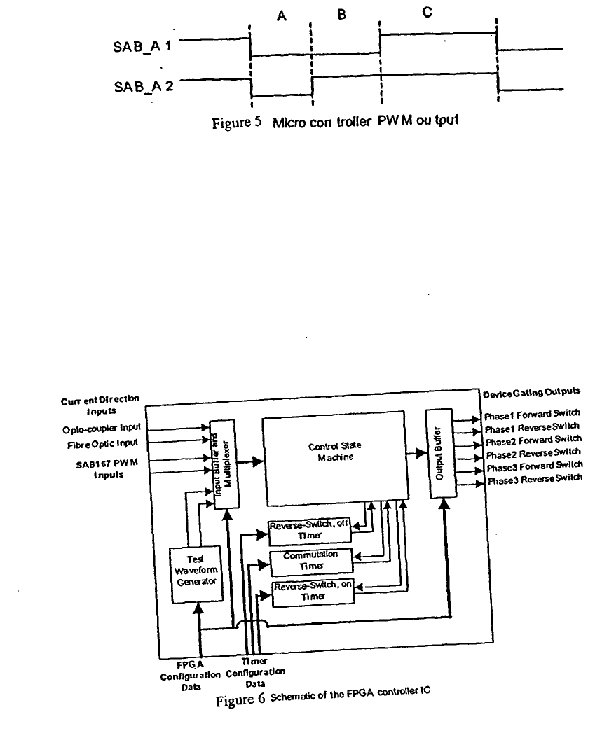

FIG. 5 shows the micro controller output of the converter of FIG. 1;

FIG. 6 shows the controller of the converter of FIG. 1;

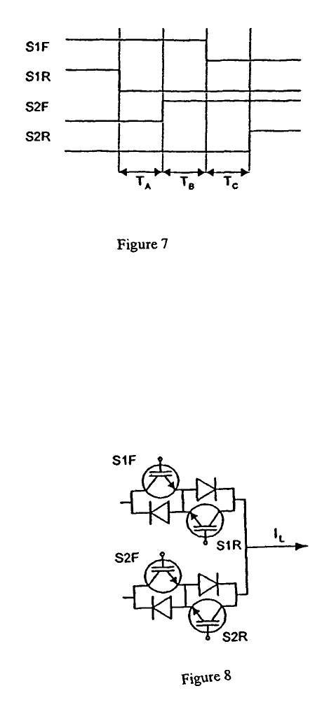

FIGS. 7 and 8 show the waveforms and switch arrangement for the four-step commutation process of the converter of FIG. 1.

A snubblerless 10 KVA Matrix Converter uses discrete 65 Amp, 1200 Volt MOS Controlled Thyristors (MCTs) as shown in FIG. 1. The commutation time is minimised in order to achieve the optimum waveform quality; this is particularly useful when controlling induction motors in applications where the controller may demand very low output voltages.

One application is in electric vehicle applications, primarily for motor control. In electric vehicles, especially military vehicles, weight and volume reduction are critical. Further, high-temperature operation is desirable to ease the problem of thermal management.

The matrix converter of the present invention can have significant advantages over the traditional dc link converter in all of these areas, since it is possible to eliminate the dc link capacitor. Previously, most matrix converters have been concerned with insulated-gate bipolar transistor (IBGT) switches.

The converter is controlled using a Venturini Control algorithm implemented on a simple micro controller.

A FPGA controls the current commutation process. This hardware control platform allows the commutation time, T_{B}, to be set by the user, with a minimum time of 100 nsecs, which is very small compared to the switching time of the devices used (about 6 usecs).

FIG. 2B shows the Matrix Converter operating with an output frequency of 40 Hz into a 11 kW induction motor load. The input filter is formed with the inductance of the paralleling inductors of the variac which supplies converter and the 15 uF capacitors attached to the input power planes. The three-step current commutation strategy operates well, there being no output voltage spikes and no input current spikes which would be seen during a commutation error of failure. The output voltage waveform is very clean, the laminated bus bar structure of the input voltage power planes producing a very small voltage overshoot during the voltage transients.

If the commutation time is increased to 10 usecs, then at very low frequencies the output has a DC bias much larger than the AC current. This DC current is due to the commutation strategy deciding a current direction for each output leg of the converter when the converter has zero current flowing, for example at turn-on.

The distortion due to the long commutation time results in a large DC voltage in the chosen direction, leading to a very significant DC current.

The improved output current waveforms obtained with a commutation time of 100 nsecs can be seen in the quality of the output current shown in FIG. 2A.

This result was obtained with the MCT Matrix Converter operating under closed loop vector control with a demand shaft speed of 3 rpm. It shows the high quality of waveform that may be obtained from the converter even with a very low output voltage demand.

In the present invention, the critical commutation time, t_{B} in FIG. 7, for an MCT matrix converter is minimised towards, and to zero, and hence the output waveform quality can be substantially enhanced, particularly under conditions of low converter output voltage demand.

This is particularly important in applications such as vector-controlled induction motor drives, in which output current distortion can cause problems under low speed conditions. These techniques can be applied to a Matrix Converter utilizing any switching device where the turn-off delay is greater than the turn-on delay.

The four-step matrix converter driver and control board contains all necessary components to provide firing signals for a three-phase to single-phase matrix converter. The four step semi-soft commutation method is implemented using a single Field Programmable Gate Array (FPGA) with a structure of allowing all of the necessary control logic to be integrated into one IC. With the critical commutation time, t_{B} effectively reduced to zero, this becomes a three-step commutation method.

Functions, such as timers, PWM generators and state machines, are used to create a stable commutation process. The timers are configurable and extremely versatile to allow use of a wide variety of semiconductor devices with different switching speeds. A docking port for a micro controller card is provided. Analogue receivers and conditioners are included for the necessary feedback signals. For convenience and noise immunity reasons, only one 5V supply is need for the board. All other necessary power supplies are generated locally.

Board Layout

FIG. 3 shows the board with the following elements:—

A: Analogue Circuitry Area: contains all of the analogue circuitry used for voltage and current measurement. The functions of this part are described in Section 3.

B: Micro Controller Port: this is the docking port for the micro controller card. The connections to this port are described in Section 4.4.

C: Current Direction Inputs: These are used by the FPGA Controller to determine the switching strategy during a current commutation. These are described more fully in Section 4.1.

D: Boot Loading Peripherals: The boot loading peripherals and some considerations are described in Section 4.2

E: Configuration DIP Switches: these are used to configure the various functions and the timers of the FPGA Controller, and are described in Section 5.1.

F: FPGA Controller: the controller provides an interface between the desired PWM output of the SAB167 micro controller and the current commutation process. Many test modes have also been implemented for convenience. These modes and the operation of the FPGA controller are described in Section 5.

G: Edge Connector: The connections to the edge connector are described in Section 4.5.

H: Power Connector: Although power to the board can be applied using the edge connector, a power terminal block is provided for convenience. The board uses only one 5 volt supply. Any other voltages needed are generated on the board. The +5V terminal is the one nearest the analogue circuitry.

I: Push Buttons: Three push buttons are included for performing tasks that occur frequently. The two that are set close together are used for enabling and disabling the output of the FPGA controller during test mode operation. The one nearest the fibre optic receiver is used for enabling the outputs. The third push button is used to reset the micro controller.

J: Fibre Optic Outputs: The fibre optic outputs and their drivers are discussed in Section 4.3.

Section 4: Analogue Circuits

The analogue area of the board allows voltage and current inputs to be transformed so that the micro controller can sample them. High Impedance 15V differential inputs are provided to reduce conducted noise. This stage has a gain of ⅓. The next stage is an offset and gain stage. The micro controller can only sample positive voltages so an offset is used to move the input waveforms. The offset voltage for all stages is controlled by the potentiometer and the op-amp at the bottom right of the analogue circuit area. The final gain and offset are then fine-tuned by the variable resistors.

The upper resistor in each channel controls the gain and the lower controls the offset.

The micro-controller has only one integrated sample-and-hold channel since large amounts of silicon area are used up by these. These multiple voltages cannot be sampled at the same instant in time. For this reason, a dedicated sample-and-hold chip (Analog Device SMP04E) is included on the board.

The analogue-to-digital converter of the SAS167 accepts inputs in the range of between 0-5V. For this range to be achieved, the Varef pin of the processor needs to be connected to the 5V rail. It has been found that noise on the 5V rail caused by the SAB167 is transferred to the sampled analogue data. For this reason, a stable 4V reference has been placed on the board. This then reduces the input range of the micro controller to 0-4V. The previously described circuitry is used to ensure the input voltage range is not exceeded.

The OP-Amps require supply voltages of +15V and the S/H integrated circuits uses +8V and −5V. All of these voltages are generated by the onboard DC-DC converter and the linear regulators from the 5V supply. This also makes the analogue circuitry more immune to digital noise.

Section 4: Peripherals

4.1 Current Direction Inputs

The current direction information is used by the FPGA Controller to determine the firing sequence during a current commutation. The FPGA Controller has two current direction inputs that can be used. The first is connected to a fibre optic receiver (HFBR2521). The second is connected to an opto-coupler (HCPL2611). Connection to the opto-coupler is through an SMB connector with the anode of the opto-coupler connected to the centre pin.

The second current direction input is also wire-Ored to an auxiliary MOSFET and can be driven from the edge connector. The gate of the MOSFET is optimised for 5V signals. Only one of these signals is used for the commutation process. The signal that is used depends on the configuration DIP switches (see Section 5.1.1). The current direction signal can also be forced to a particular direction internally for testing purposes. The design of the FPGA controller ensures that there are no external filtering or latching requirements for the signal.

4.2 Boot-Loader Considerations

For convenience, a 9-way D-type connector is included on the board for pre-rack mounting testing. Only a standard serial port extension cable is required. The connections are such that no null modem wire swapping is required. The TQM167LCD serial port lines are also connected to the edge connector for future use. The PC serial port lines RTS and DTR are used to reset and bootload the micro controller.

After bootloading, these lines can be toggled by the terminal program used to communicate with the micro controller causing a reset to occur. As a safety measure, two jumpers are used to break the connections of the RTS and DTR lines when not bootloading. Only the TxD and RxD lines are required to communicate with the micro controller during normal operations. If preferred, the connector on top of the TQM167LCD can be used. Care must then be taken with the RTS and DTR lines for the reasons outlined above.

4.3 Fibre Optic Drivers

The output gate drive fibre optic components (HFBR 1521) are driven by a series connection of a MOSFET, resistor and the opto diode. The MOSFET is directly driven by the FPGA controller. The polarity of the outputs (active high or active low) can be changed to suit the application (see Section 5.1.5). The fibre optic transmitter at the top of the board of FIG. 3 is used for the forward device in commutation cell number 1 (1F), the next is for the reverse device (1R) and so on. This can be seen more clearly in FIG. 4.

4.4 Micro Controller Port

All of the necessary connections to the micro controller card are provided using the two connectors on the board. These connections include the analogue signal lines together with the analogue reference, the serial port lines and connections to the FPGA controller. Three lines are used to connect the SAB167 and the FPGA. One line is used as an enable line. The other two are used for the PWM demand. FIG. 5 shows a typical PWM output period from the micro controller. The decoding of these signals into the three six output signals is done internally in the FPGA controller. During period A, the outputs of commutation cell 1 are active, during B cell 2 is active and finally during C cell 3 is active. If the FPGA controller is set to use the SAB167 PWM inputs (i.e not using one of the test modes), the push button enable and disable push buttons are not active. Only the enable line from the SAB167 is used to enable and disable the FPGA outputs. A line is also used for to trigger the sample and hold IC.

Edge Connector

TABLE 1

| Pin Number | Usage |
|---|---|
| 1 | Analogue channel 1 +ve |
| 2 | Analogue channel 1 −ve |
| 3 | Analogue channel 2 +ve |
| 4 | Analogue channel 2 −ve |
| 5 | Analogue channel 3 +ve |
| 6 | Analogue channel 3 −ve |
| 7 | Analogue channel 4 +ve |
| 8 | Analogue channel 4 −ve |
| 15 | 5 V Power supply input |
| 16 | 0 V Power supply input |
| 18 | Serial Port DTR |
| 19 | Serial Port RTS |
| 20 | Serial Port TxD |
| 21 | Serial Port RxD |
| 22 | AUX current direction input |
| All Other | Not Used |

FIG. 4B and Table 1 above show the connections to the edge connector. All connections are made to the underside of the edge connector with the exception of the power supply connections which are attached to both the underside and the component side.

5. FPGA Controller

FIG. 6 shows a high level schematic of the FPGA controller. The FPGA acts an interface between the PWM demands of the micro controller and the output requirements of the commutation process. The output stage is controlled in such a way as to implement the standard 4-step semi-soft commutation strategy to avoid line to line short circuits or load open circuits. The FPGA contains all the necessary, circuitry to implement the three necessary timers and the current direction input conditioning. Various test modes are also included for converter operation without the need to the micro controller using an internal PWM generator. These modes are described in Section 5.1.2. The FPGA is configured with the use of DIP switches on the board. The polarity of the output stage and the current direction inputs can be changed according to the desired application thus removing constraints on providing external inverters for interfacing.

5.1 FPGA Configuration

The DIP switches produce a logic 0 is switched to the “on” position and floats to a logic “1” if in the “off” position. Table 2 below shows the pin naming convention for the FPGA configuration DIP switches (labelled “Config” on the board).

TABLE 2

| | Switch No. | | | | | | | | | |
|---|---|---|---|---|---|---|---|---|---|---|
| | 1 | 2 | 3 | 4 | 5 | 6 | 7 | 8 | 9 | 10 |
| Switch Name | Cinconf1 | Cinconf2 | Test1 | Test2 | Test3 | Testap1 | Testsp2 | Globaldiv2 | Activeout | Activecin |

5.1.1 Cincon1, Cincon2

These two switches configure the current direction input. They are used to select either one of the current direction inputs described earlier or to force the current direction to one value or the other during testing. The current direction is defined as positive (logic 1) if it is flowing out of the converter from the utility to the load and negative if current is flowing into the converter from the load to the utility (logic 0). Table 3 below shows the operation of the switches.

TABLE 3

| Cinconf1 | Cinconf2 | Operation |
|---|---|---|
| 0 | 0 | CIN1 Selected (fibre optic) |
| 0 | 1 | CIN2 Selected (optocoupler/Aux) |
| 1 | 0 | Current direction forced to 0 |
| 1 | 1 | Current direction forced to 1 |

5.1.2 Test1, Test2, Test3

These three switches configure the mode of operation of the FPGA. Under normal operation the FPGA controller uses the PWM of the micro controller to derive the output waveforms. There are however various test modes to aid in the development process. These modes include a three phase commutation with a cells 1, 2 and 3 given a 25%, 25% and 50% duty cycle respectively. The test generator can also commutate between two desired phases with a 50% duty cycle. Table 4 below shows all of the possibilities.

TABLE 4

| Test1 | Test2 | Test3 | Operation |
|---|---|---|---|
| 0 | 0 | 0 | SAB167 Controlled |
| 0 | 0 | 1 | 3 Phase Test mode |
| 0 | 1 | X | 2 phase commutate between cells 1 and 2 |
| 1 | 0 | X | 2 phase commutate between cells 2 and 3 |
| 1 | 1 | X | 2 phase commutate between cells 3 and 1 |

NOTE:
When the FPGA Controller is set to be controlled by the micro controller the push button enable and disable are not active. The outputs are enabled by the micro controller.

5.1.3 Testp1, Testp2

These switches control the switching frequency of the test mode PWM generator. Table 5 below shows the available combinations.

TABLE 5

| Testsp1 | Testsp2 | Frequency | |
|---|---|---|---|
| 0 | 0 | 5 | kHz |
| 0 | 1 | 2.5 | kHz |
| 1 | 0 | 1.25 | kHz |
| 1 | 1 | 625 | Hz |

5.1.4 Globaldiv2

This switch is used when longer delays are required. All internal timer clocks are halved in frequency when this is set to 0. Normal system clock speed is used when set to 1. This will be described more fully in section 5.2

5.1.5 Activein, Activeout

The activein and activeout switches control the polarity of the outputs and the CIN inputs. If activeout is set to 1, a 1 will appear at the output of the FPGA (the fibre optic transmitter will be driven) when a device should be turned on. The reverse is true if the switch is set to 0.

As mentioned earlier a positive current (flowing from utility to load) is internally represented by a logic 1. This can be inverted inside the FPGA so that the designer need not worry about signal polarity when designing the current direction detection circuitry. If activein is set to logic 1, it is assumed that a logic 1 on the input to the FPGA is positive current (i.e active high). If the activein is set to 0 then a 0 at the input to the FPGA will mean positive current flow (i.e current direction is then active low). Any inversion due to the on board current direction receiving components also need to be taken into consideration. Setting activecin to either value will not affect the direction value if the current direction is forced using one of the test modes.

5.2 Timer Configuration

FIG. 7 shows the output waveforms achieved by the switches shown in FIG. 8 for the commutation from cell 1 to switch cell 2 assuming the current to be in the direction shown. The times marked T_{A}, T_{B} and T_{C} are defined as the “reverse switch off time”, the “commutation time” and the “reverse switch on time” respectively. Each of these delays has its own configurable timer. Each of the three DIP switches are identical and control one timer each. The “reverse switch off time” timer is marked “R-off” on the board, the “commutation time” timer is marked “Comm” and the “reverse switch on time” timer is marked “R-on”. Since each of the timer configuration settings are identical, only one will be described. Table 6 shows the switch usage for the commutation timer.

TABLE 6

| Switch No. | Switch Name |
|---|---|
| 1 | CommDiv1 |
| 2 | CommDiv0 |
| 3 | Not Used |
| 4 | CommDIP7 |
| 5 | CommDIP6 |
| 6 | CommDIP5 |
| 7 | CommDIP4 |
| 8 | CommDIP3 |
| 9 | CommDIP2 |
| 10 | CommDIP1 |

The switches labelled “CommDIP1-7” form the input to a 7-bit binary counter, CommDIP1 being the “least significant bit” and CommDIP7 being the “most significant bit”. The timer counts up to the value specified on the CommDIP switches before resetting to create the variable delay required. The switches labelled CommDIV0-1 are used to dictate the input clock speed into the timer. Table 7 below shows all available clock periods assuming 10 MHz clock is used to clock the FPGA controller.

TABLE 7

| CommDIV1 | CommDIV0 | Period |
|---|---|---|
| 0 | 0 | 100 ns |
| 0 | 1 | 200 ns |
| 1 | 0 | 400 ns |
| 1 | 1 | 800 ns |

If the Globaldiv2 input is set to 0, these times are doubled for all timers. The timer time is calculated by multiplying the selected clock period by the binary number set on the CommDIP switches (remembering that a logic 0 is produced when the switch is on and a 1 when off when setting the DIP switches) and then adding one FPGA clock period (100 ns for the 10 MHZ clock). For example, if the timer was to be set to its maximum value (Globaldiv2 is also set to 0 to double the delay), all seven bits set to high on the CommDIP switches will cause a maximum count of 127, this multiplied by a period of 1.6μ gives 203.2 μs plus 100 ns gives a maximum delay of 203.3 μs. If the CommDIP switches are all set to zero, then the timer delay is set to 100 ns. This wide range of timer values makes the FPGA controller suitable for most types of semiconductor switching devices. The “reverse off” and “reverse on” timers are configured in the same way.

TABLE 8

| Switch No. | Switch Name |
|---|---|
| 1 | R-offDIV1 |
| 2 | R-offDIV0 |
| 3 | Not Used |
| 4 | R-offDIP7 |
| 5 | R-offDIP6 |
| 6 | R-offDIP5 |
| 7 | R-offDIP4 |
| 8 | R-offDIP3 |
| 9 | R-offDIP2 |
| 10 | R-offDIP1 |

‘reverse off timer’

TABLE 9

| Switch No. | Switch Name |
|---|---|
| 1 | R-onDIV1 |
| 2 | R-onDIV0 |
| 3 | Not Used |
| 4 | R-onDIP7 |
| 5 | R-onDIP6 |
| 6 | R-onDIP5 |
| 7 | R-onDIP4 |
| 8 | R-onDIP3 |
| 9 | R-onDIP2 |
| 10 | R-onDIP1 |

‘reverse on timer’
The formula below can be used to calculate timer periods where:-
DIP represents the binary number on the DIP switches (DIP1 = LSB, DIP7 = MSB).
DIV represents the binary number on the DIV0 and DIV1 switches (DIV0 = LSB, DIV1 = MSB).
CLK is the global clock period, normally 100 ns but if Globaldiv2 is set to 0 CLK = 200 ns.
Timer Period = (CLK × 2^{DIV} × DIP) + 100 ns
Example: If CLK = 100 ns, DIV0 and DIV1 are both set to 1 and 45 is set on the DIP switches, the resulting timer period would be,
(100 ns × 2³ × 45) + 100 ns = 36.1 μs

| Pin Number | Pin Use |
|---|---|
| 1 | DEB UG_PIN |
| 2 | PWR-RESET |
| 3 | SAB-A1 |
| 4 | Reserved for Future Use |
| 5 | SAB-A2 |
| 6 | GND |
| 7 | SAB-ENABLE |
| 8 | Reserved for Future Use |
| 9 | CINconf1 |
| 10 | TEST1 |
| 11 | CINconf2 |
| 12 | GND |
| 13 | TEST2 |
| 14 | TEST3 |
| 15 | TEST-SP1 |
| 16 | TEST-SP2 |
| 17 | Global-DIV2 |
| 18 | active-out |
| 19 | active-cin |
| 20 | R-on DIV1 |
| 21 | Reserved for Future Use |
| 22 | VCC |
| 23 | VCC |
| 24 | R-off DIV1 |
| 25 | R-off DIV1 |
| 26 | R-on DIV0 |
| 27 | R-off DIV0 |
| 28 | GND |
| 29 | R-off DIP7 |
| 30 | R-off DIV0 |
| 31 | R-off DIP7 |
| 32 | R-on DIP7 |
| 33 | R-on DIP6 |
| 34 | R-off DIP6 |
| 35 | R-off DIP6 |
| 36 | R-off DIP5 |
| 37 | R-on DIP5 |
| 38 | R-on DIP4 |
| 39 | R-off DIP5 |
| 40 | R-off DIP4 |
| 41 | R-off DIP4 |
| 42 | R-on DIP3 |
| 43 | VCC |
| 44 | R-off DIP3 |
| 45 | R-off DIP2 |
| 46 | R-off DIP3 |
| 47 | R-on DIP1 |
| 48 | R-on DIP2 |
| 49 | GND |
| 50 | R-off DIP2 |
| 51 | EXT-Disable |
| 52 | R-off DIP1 |
| 53 | Reserved for Future Use |
| 54 | CIN-LED |
| 55 | EXT-Enable |
| 56 | ENABLE-LED |
| 57 | CIN2 (opto/AUX) |
| 58 | Reserved for Future Use |
| 59 | R-off DIP1 |
| 60 | Reserved for Future Use |
| 61 | Reserved for Future Use |
| 62 | Reserved for Future Use |
| 63 | GND |
| 64 | VCC |
| 65 | VCC |
| 66 | CIN1 |
| 67 | Reserved for Future Use |
| 68 | Reserved for Future Use |
| 69 | Reserved for Future Use |
| 70 | GND |
| 71 | 3R |
| 72 | 3F |
| 73 | 2R |
| 74 | 2F |
| 75 | 1F |
| 76 | 1R |
| 77 | Reserved for Future Use |
| 78 | Reserved for Future Use |
| 79 | Reserved for Future Use |
| 80 | Reserved for Future Use |
| 81 | Reserved for Future Use |
| 82 | Reserved for Future Use |
| 83 | CLK |
| 84 | VCC |

Table 10 gives FPGA pin definitions

Timer DIP Switch Setting Examples

Table 11 below gives some examples of possible timer DIP switch settings and their resultant delay times.

TABLE 11

| | | | DIP | | | | | | | | |
|---|---|---|---|---|---|---|---|---|---|---|---|
| Globaldiv2 | DIV1 | DIV0 | 7 | 6 | 5 | 4 | 3 | 2 | 1 | DELAY | |
| 1 | 0 | 0 | 0 | 0 | 0 | 0 | 0 | 0 | 0 | 100 | ns |
| 1 | 0 | 0 | 0 | 0 | 0 | 0 | 1 | 0 | 0 | 500 | ns |
| 1 | 0 | 0 | 0 | 0 | 0 | 1 | 0 | 0 | 1 | 1 | μs |
| 1 | 0 | 1 | 0 | 0 | 0 | 0 | 1 | 0 | 0 | 900 | ns |
| 1 | 0 | 1 | 0 | 0 | 0 | 1 | 0 | 1 | 0 | 2.1 | μs |
| 1 | 1 | 0 | 0 | 1 | 1 | 0 | 0 | 1 | 0 | 20.1 | μs |
| 1 | 1 | 0 | 1 | 1 | 1 | 1 | 1 | 1 | 1 | 50.9 | μs |
| 1 | 1 | 1 | 0 | 0 | 0 | 1 | 0 | 0 | 0 | 6.5 | μs |
| 1 | 1 | 1 | 1 | 0 | 0 | 0 | 0 | 0 | 0 | 51.3 | |
| 0 | 0 | 0 | 0 | 0 | 0 | 0 | 1 | 0 | 0 | 900 | ns |
| 0 | 0 | 0 | 0 | 0 | 0 | 1 | 0 | 0 | 1 | 1.9 | μs |
| 0 | 0 | 1 | 0 | 0 | 0 | 0 | 1 | 0 | 0 | 1.7 | μs |
| 0 | 0 | 1 | 0 | 0 | 0 | 1 | 0 | 1 | 0 | 4.1 | μs |
| 0 | 1 | 0 | 0 | 1 | 1 | 0 | 0 | 1 | 0 | 40.1 | μs |
| 0 | 1 | 0 | 1 | 1 | 1 | 1 | 1 | 1 | 1 | 101.7 | μs |
| 0 | 1 | 1 | 0 | 0 | 0 | 1 | 0 | 0 | 0 | 12.9 | μs |
| 0 | 1 | 1 | 1 | 0 | 0 | 0 | 0 | 0 | 0 | 102.5 | |
| 0 | 1 | 1 | 1 | 1 | 1 | 1 | 1 | 1 | 1 | 203.3 | |

The switch names used are general since they can be applied to any of the three timers.

1. A converter having a plurality of bi-directional switch means arranged in a configuration, the converter comprising current commutation means to effect operation of the switch means to begin initiation of one switch means before de-activation of another switch means.

2. A converter according to claim 1 comprising a first switch means and a second switch means whereby, in a first mode in use, the first switch means is activated and the second switch means is not activated, and the current commutation means is operable to activate the second switch means before the first switch means is de-activated.

3. A converter according to any preceding claim wherein the operating means comprises means to minimise the commutation interval.

4. A converter according to any preceding claim wherein the operating means comprises means to provide a commutation interval of less than those typically used as the deadtime in a Voltage Source Inverter.

5. A converter according to any preceding claim wherein the operating means comprises means to provide a commutation interval which approaches or equals zero.

6. A converter according to any preceding claim wherein the operating means comprises means to provide a commutation interval which is slightly negative.

7. A converter according to claim 1 wherein the operating means comprises means to provide a commutation interval which is negative up to the total turn-off delays and times of the switching devices used for the converter realisation.

8. A converter according to any preceding claim wherein the converter comprises a plurality of switches and timers thereby to effect reduction of the commutation interval.

9. A converter substantially as hereinbefore described with reference to, and/or as illustrated in, any one or more of the Figures of the accompanying drawings.

10. A method of operating a converter having a plurality of bi-directional switch means arranged in a configuration, the method comprising effecting current commutation to operate the switching means to begin activation of one switch means before de-activation of another switch means.

11. A method according to claim 10 comprising operating the current commutation means in order to activate a second switch means before a first switch means is de-activated.

12. A method according to claim 10 or 11 comprising minimising the commutation interval.

13. A method according to any of claims 10 to 17 comprising providing commutation interval of less than those typically used as the deadtime in a Voltage Source Inverter.

14. A method according to any of claims 10 to 13 comprising providing a commutation interval which approaches or equals zero.

15. A method according to any of claims 10 to 14 comprising providing a commutation interval which is slightly negative.

16. A method according to any of claims 10 to 15 comprising a commutation interval which is negative up to the total turn-off delays and times of the switching devices used for the converter realisation.

17. A method comprising operating a plurality of switches and timers thereby to effect reduction of the commutation interval.

18. A method substantially as hereinbefore described with reference to, and/or as illustrated in, any one or more of the Figures of the accompanying drawings.

19. A computer program product directly loadable into the internal memory of a digital computer, comprising software code portions for performing the steps of any one of claims 10 to 18 when said product is run on a computer.

20. A computer program directly loadable into the internal memory of a digital computer, comprising software code portions for performing the steps of any one of claims 10 to 18 when said program is run on a computer.

21. A carrier, which may comprise electronic signals, for a computer program of claim 20.

22. Electronic distribution of a computer program product of claim 19 or a computer program of claim 20 or a carrier of claim 21.
